(19) United States
(12) Patent Application Publication
(10) Pub. No.: US 2004/0232334 A1
(43) Pub. Date: Nov. 25, 2004

(54) Apparatus and method of control of unruly persons

(76) Inventor: Laurence Gainsborough, Winnipeg (CA)

Correspondence Address: ADE & COMPANY, 1700-360 MAIN STREET, WINNIPEG, MB, R3C3Z3, CA

(21) Appl. No.: 10/792,921

(22) Filed: Mar. 5, 2004

Related U.S. Application Data
(63) Continuation-in-part of application No. 09/922,007, filed on Aug. 6, 2001.

(30) Foreign Application Priority Data
Aug. 3, 2001 (CA) 2,354,744

(51) Int. Cl. G01J 1/00; F41H 9/08; F41H 13/00

(52) U.S. Cl. 250/330; 89/1.11; 102/334; 102/367; 348/77; 348/164; 340/944

(57) ABSTRACT

A method of controlling unruly persons comprising identifying an area containing unruly persons refusing to respond to rule of law, filling the area with a non-toxic, non-injurious fogging material which interferes with the visual sense of persons in the area so as to prevent the persons from orienting themselves within the area and prevents the persons from seeing other persons within the area and providing for at least one authorized person within the area a thermal imaging camera operable to thermally detect persons within the area and to generate an image representing the persons detected. At least one authorized person within the area a viewing device for viewing the image of the detected persons and causing said at least one authorized person to subdue the unruly persons while viewing the images of the unruly persons and while the unruly persons are prevented from seeing the at least one authorized person.

This application is a Continuation-in-Part Application of parent application Ser. No. 09/922,007, filed Aug. 6, 2001.

### FIELD OF THE INVENTION

The present invention relates to an apparatus and method of controlling unruly persons during hostage taking, law enforcement and other situations.

### BACKGROUND

Conventional methods of dealing with riot situations in correctional facilities and the like require a large number of guards, correctional officers or special riot squads to subdue the unruly persons involved. The guards or Correctional Officers must also endure a lot of physical violence to the unruly persons and to themselves. Controlling these situations can be very dangerous and violent and the conventional methods used can generate increased violence. Commonly, the unruly individuals usually are sprayed with a gas, generally a combination of tear gas and pepper gas, then restraint is attempted using dogs, flash bangs and truncheons. With further defensive manoeuvres consisting of firing pepper balls, rubber bullets bean bags and the like which can cause serious injuries or can be fatal.

### SUMMARY

According to the present invention there is provided a method of controlling unruly persons comprising:

identifying an area containing unruly persons refusing to respond to rule of law;

filling the area with a non-toxic, non-injurious, non-lethal, non-irritant, non-contaminant, non-conductive and non-corrosive fogging material which instantly inhibits sight and movement of occupants—disorientation, loss of visual and auditory senses of persons in the area so as to prevent the persons from orienting themselves within the area and prevents the persons from seeing other persons within the area;

providing for at least one authorized person within the area a thermal imaging camera operable to thermally detect persons within the area and to generate an image representing the persons detected;

providing for said at least one authorized person within the area a viewing device for viewing the image of the detected persons;

and causing said at least one authorized person to subdue the unruly persons while viewing the images of the unruly persons and while the unruly persons are prevented from seeing the at least one authorized person.

Preferably the camera is mounted on a headpiece arranged to be carried on the head of the authorized person so as to be movable with the head.

Preferably the camera is arranged to be carried on a helmet of the authorized person.

Conveniently the viewing device is mounted on a support to be carried in front of one eye of the authorized person.

Conveniently the viewing device is mounted on a helmet of the authorized person.

Preferably a thermal imaging camera operable to thermally detect persons within the area and to generate an image representing the persons detected and recording the images of the persons in the area to maintain a record of the activities in the area.

Preferably the unruly persons are subdued one at a time.

The unruly persons are subdued by pepper spray.

Preferably the unruly persons are subdued by manual manipulation.

The unruly persons are prisoners in a correctional institution.

The unruly persons are rioters.

According to an aspect of the present invention there is provided an apparatus for use in controlling unruly persons comprising:

a fog generating machine for filling an area with a non-toxic, non-injurious fogging material which interferes with the visual sense of persons in the area so as to prevent the persons from orienting themselves within the area and prevents the persons from seeing other persons within the area;

a thermal imaging camera operable to thermally detect persons within the area and to generate an image representing the persons detected;

a viewing device for viewing the image of the detected persons;

wherein the camera is mounted on a headpiece arranged to be carried on the head of an authorized person so as to be movable with the head;

and wherein the viewing device is mounted on a support to be carried in front of one eye of the authorized person.

Preferably the camera is arranged to be carried on a helmet of the authorized person.

Preferably the viewing device is mounted on a helmet of the authorized person.

Preferably there is provided a thermal imaging camera operable to thermally detect persons within the area and to generate an image representing the persons detected and recording the images of the persons in the area to maintain a record of the activities in the area.

### BRIEF DESCRIPTION OF THE DRAWINGS

In the accompanying drawings, which illustrate an exemplary embodiment of the present invention:

FIG. 1 is a schematic view of the invention.

FIG. 2 is a schematic view of the invention in a subdued scenario.

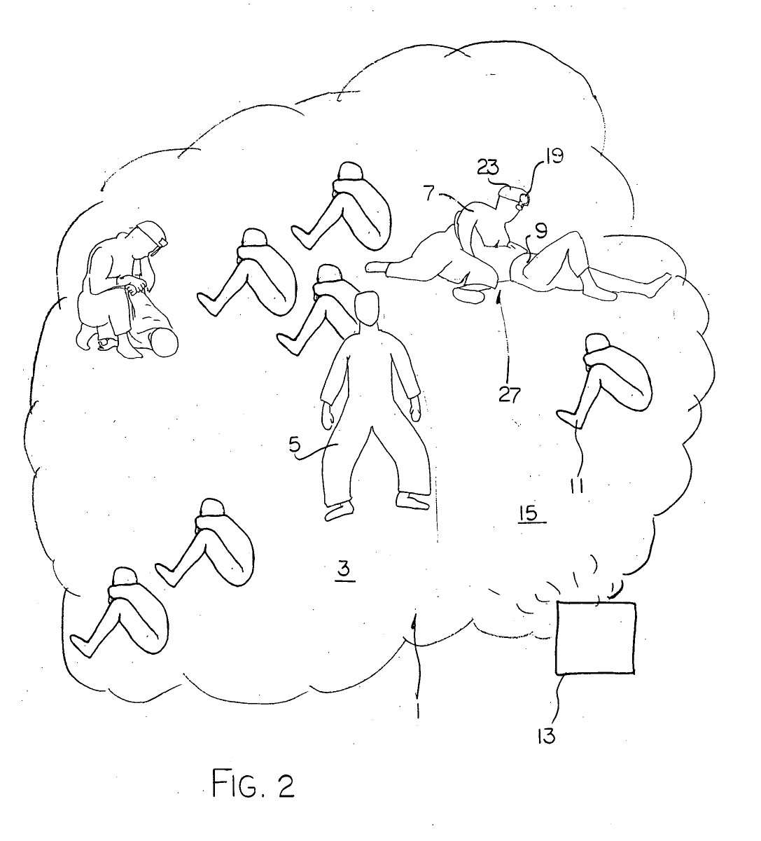

### DETAILED DESCRIPTION

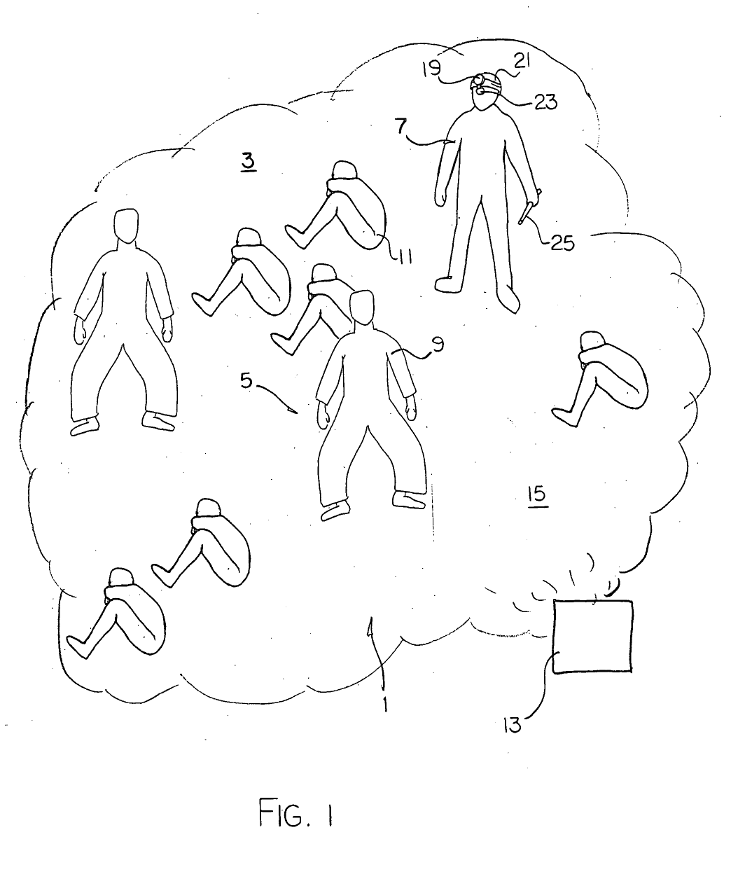

As illustrated in the accompanying drawings, there is illustrated an apparatus and a method of control of unruly persons. FIG. 1 illustrates a scenario in which the apparatus and method are used. The scenario includes an area 1 such as a compound in a correctional facility 3. The area can be within the confounds of the facility or outside such as in an exercise compound. The area is anywhere a situation in which unruly persons may be rioting and the like. In conventional systems at correctional facilities there are rules of engagement and rules for the inmates during riot situations. A rule for a inmate 5 during a riot is to lye on the ground or sit so that guards or riot squad 7 can differentiate an unruly person 9 and a uninvolved person 11. Every person not lying or sitting is seen as a threat or danger to the guards during a riot and is treated accordingly.

In the event of a riot, a fog generating machine 13 distributes a dense fog 15 in the area. The fog is non-lethal, non-injurious, non-toxic, non-irritant, non-contaminant, non-conductive and non corrosive. The fog instantly inhibits sight and movement of the inmates and causes disorientation, loss of visual and auditory senses. The fog demobilises the inmates through the loss of visual and auditory senses thereby stopping any further violent acts by the unruly inmates.

The guards are provided with a thermal imaging camera 19 which is mounted on a helmet or head set 21. The thermal imaging camera provides a visual advantage to the guards and allows them to locate the unruly inmates. The head set has an eye piece 23 which is located in front of the guards eyes which allows the guard to view the image from the thermal imaging camera. The guard is able to see the unruly inmates, the uninvolved inmates as well as any weapons and the like the inmates may be carrying. This provides the guards with time to assemble a controlled and organised dispersal of the inmates. The guards are trained to control the inmates by necessary force. The fog allows the guards to confront the unruly inmates without detection and to subdue the inmates minimal violence to the inmate and the guard, as indicated by reference numeral 27. The guard may see necessary to carry pepper spray 25 or the like providing an added method of subduing the unruly inmate.

While one embodiment of the present invention has been described in the foregoing, it is to be understood that other embodiments are possible within the scope of the invention. The invention is to be considered limited solely by the scope of the appended claims.

1. A method of controlling unruly persons comprising:
identifying an area containing unruly persons refusing to respond to rule of law;
filling the area with a non-toxic, non-injurious fogging material which interferes with the visual sense of persons in the area so as to prevent the persons from orienting themselves within the area and prevents the persons from seeing other persons within the area;
providing for at least one authorized person within the area a thermal imaging camera operable to thermally detect persons within the area and to generate an image representing the persons detected;
providing for said at least one authorized person within the area a viewing device for viewing the image of the detected persons;
and causing said at least one authorized person to subdue the unruly persons while viewing the images of the unruly persons and while the unruly persons are prevented from seeing the at least one authorized person.

2. The method according to claim 1 wherein the camera is mounted on a headpiece arranged to be carried on the head of the authorized person so as to be movable with the head.

3. The method according to claim 2 wherein the camera is arranged to be carried on a helmet of the authorized person.

4. The method according to claim 1 wherein the viewing device is mounted on a support to be carried in front of one eye of the authorized person.

5. The method according to claim 4 wherein the viewing device is mounted on a helmet of the authorized person.

6. The method according to claim 1 including providing a thermal imaging camera operable to thermally detect persons within the area and to generate an image representing the persons detected and recording the images of the persons in the area to maintain a record of the activities in the area.

7. The method according to claim 1 wherein the unruly persons are subdued one at a time.

8. The method according to claim 7 wherein the unruly persons are subdued by pepper spray.

9. The method according to claim 7 wherein the unruly persons are subdued by manual manipulation.

10. The method according to claim 1 wherein the unruly persons are prisoners in a correctional institution.

11. The method according to claim 1 wherein the unruly persons are rioters.

12. An apparatus for use in controlling unruly persons comprising:
a fog generating machine for filling an area with a non-toxic, non-injurious fogging material which interferes with the visual sense of persons in the area so as to prevent the persons from orienting themselves within the area and prevents the persons from seeing other persons within the area;
a thermal imaging camera operable to thermally detect persons within the area and to generate an image representing the persons detected;
a viewing device for viewing the image of the detected persons;
wherein the camera is mounted on a headpiece arranged to be carried on the head of an authorized person so as to be movable with the head;
and wherein the viewing device is mounted on a support to be carried in front of one eye of the authorized person.

13. The apparatus according to claim 12 wherein the camera is arranged to be carried on a helmet of the authorized person.

14. The apparatus according to claim 12 wherein the viewing device is mounted on a helmet of the authorized person.

15. The apparatus according to claim 12 wherein there is provided a thermal imaging camera operable to thermally detect persons within the area and to generate an image representing the persons detected and recording the images of the persons in the area to maintain a record of the activities in the area.
